(19) United States
(12) Patent Application Publication
(10) Pub. No.: US 2004/0139230 A1
(43) Pub. Date: Jul. 15, 2004

(54) SIP service method in a network having a NAT

(75) Inventor: Seon Keon Kim, Gunpo-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/743,301

(22) Filed: Dec. 23, 2003

(30) Foreign Application Priority Data
Dec. 27, 2002 (KR) 10-2002-0084994

(51) Int. Cl. G06F 15/16

(52) U.S. Cl. 709/245; 709/227

(57) ABSTRACT

An SIP service method is provided in a network having a NAT. Private address/port of a proxy within the NAT may be registered in a static mapping table of the NAT for accessing the proxy within the NAT from outside the NAT. If messages come to the public IP address/port of the NAT mapped to the private IP address/port of the proxy, all SIP messages may be automatically transmitted to the private IP address/port of the proxy mapped to the public address. If the proxy intends to transmit messages to outside the NAT, a connection is made at the NAT to the outside using the public IP address/port mapped to the private IP address/port of the proxy.

The present application claims priority from Korean Patent Application No. 10-2002-0084994, filed Dec. 27, 2002, the subject matter of which is incorporated herein by reference.

### BACKGROUND OF THE INVENTION

1. Field of the Invention

Embodiments of the present invention may relate to a Session Initiation Protocol (SIP) service method in a network having a Network Address Translation (NAT). More particularly, embodiments of the present invention may relate to a SIP service method in a network having the NAT that enables implementation of the SIP service using a Real Time Protocol (RTP) relay and a static mapping table of the NAT.

2. Background of Related Art

A Network Address Translation (NAT) may be used as a method to resolve problems relating to exhaustion of Internet Protocols (IPs) and large routing scale. In a communication network, the NAT translates private IP addresses into public IP addresses at the network layer, which is a third layer in an OSI model. The NAT makes it possible to convert multiple private IP addresses to a limited number of public IP addresses and vice versa, and thus enables multiple users to share public IP addresses.

The NAT maps internal access information (i.e., internal IP address/port pair) to external or public access information (i.e., external or public IP address/port pair). Depending on whether a new mapping value is generated for each and every destination address (i.e., one mapping value may not be used for another address) or whether a mapping value generated for one destination address may be used for another destination address, the NAT may fall into one of four types: full cone, restricted cone, port restricted cone and symmetric.

Of the four types of NATs, the former three may use a mapping value, which was generated for connection with a certain destination address, for another destination address. For symmetric NATs, a mapping value generated for a certain destination address may not be used for any other destination address. Thus, a new mapping value may be generated for each destination address.

SIP is a standardized protocol intended for multimedia data transmission and Internet phone calls, etc. SIP may be used for initiating, modifying and terminating a session including one or more participants. On the other hand, a Session Description Protocol (SDP) may be used for describing session information in the relevant session for multimedia service communication.

FIG. 1 will be referred to in explaining a signaling process conducted before a call setup is completed and a media stream process where the call is connected and RTP data are transmitted in a situation in which SIP service are provided through the NAT.

In FIG. 1, proxies (X′,Y′) (130,230) are installed outside of NATs (120, 220). If user agents (X,Y) (110,210) of the relevant domains (Domain A, Domain B) (100,200) make SIP requests, the proxies (130,140) determine to which destinations such call requests should be transmitted. The proxies (130, 140) may also modify the relevant headers and conduct forwarding.

In FIG. 1, user agent X (SIP UA X, 110) belongs to domain A (Domain A, 100) and user agent Y (SIP UA Y, 120) belongs to domain B (Domain B, 200). If the user agent X (110) makes a call request to the user agent Y (210) belonging to a different domain, then the signaling processing may proceed as follows.

First, if the user agent X (110) sends a call request to proxy X′ (SIP Proxy X′) (130) via the NAT (120), the proxy X′ (SIP Proxy X′) (130) makes a call request by adding via header parameters (received, report) to the SIP message. In order to facilitate NAT passage at this step of signaling, all SIP messages from an invite message (for the initial call request) to a bye message (for the final call termination) must go through the proxies. Thus, the Proxy-Require and Record-Route headers are used.

On the other hand, the transmission of the call request from proxy Y′ (Proxy Y′)(230) to the user agent Y (210) through the relevant NAT 220 and the receipt of a response thereto are resolved by the user agent Y (210)'s registration with the proxy Y′ (230). If the proxy Y′ (230) and the user agent Y (210) are connected continuously or in the case of the UDP, problems of the NAT may be resolved using a ping method, translate header, expire header, and options request together with the via header parameters, etc. At this time, the proxy Y′ (230) stores the via header parameters (received, rport) obtained during the registration instead of the information in the message's contact field. In this manner, the user agent Y (210) within the NAT may be connected again for future transmission by using the stored information.

In this connection, because the keep alive time of a UDP binding of the NAT is generally about 1 minute, the user agent Y (210) must keep activating the NAT UDP binding by continuously sending register messages with a time interval shorter than 1 minute.

Once SIP signaling is finished, the user agent X (110) and the user agent Y (210) communicate with each other by transmitting RTP data to each other and thus the media stream passes through the NAT.

In order to communicate with the user agent Y (210), the user agent X (110) includes information required for receiving a media stream in the SDP message contained in the body of the SIP message (i.e., includes IP address, port and media data, etc. in the fields m=(Media) and c=(Connection)). The user agent X (110) sends this message. Thus, various methods are utilized. If the NAT is full cone type, restricted cone type or port restricted cone type, an external query and STUN (Simple Traversal of UDP through NATs) protocol, using a universal plug and play (UPnP) proposed by Microsoft and a certain specific server (NAT Probe or STUN Server), etc., may be utilized.

According to this method, the relevant terminal may directly ask the NAT for the NAT's external access information (External IP:Port) that is mapped to its internal access information (Internal IP:Port) before the signaling or the relevant terminal asks the other server (NAT probe or STUN server) to provide the information. Then, the terminal includes the NAT's external IP and port information (External IP:Port) in the fields m=(Media) and c=(Connection) of the SDP and sends such information. In this manner, NAT problems of the media stream may be resolved.

However, the above-described method (i.e., the method using NAT probe or STUN server) may be applicable only to three types of NATs. In the case of a symmetric NAT, the external user agent (210) may recognize the relevant access information (IP: Port) (NAT Binding) only after receiving the substantive RTP data from the user agent X (110). Thus, the external user agent must wait until it receives the RTP data. This is called “connection oriented media.”

At this time, the internal user agent includes the a=direction: active line (zero or more media attributes) in the SDP message and sends this information. Thus, the external agent disregards the access information (IP:Port) within the SDP message.

The above-described SIP service method in a network having a NAT may have the following problems. First, in connection with the signaling, in the SIP standard document RFC2543, rport of via header parameters is not defined as an essential item to be applied. Thus, most proxies cannot use rport for resolving the NTP problems because they would disregard rport even if rport were included in the SIP message.

Further, even though the TCP connection through RFC3261 is recommended in RFC2543, UDP is the default and TCP support was not an essential item. Thus, a lot of SIP terminals may not support TCP. Therefore, in order to provide service using UDP, NAT UDP Binding may need to be continuously activated for the proxies' connection with the terminals within the NAT. For this purpose, the terminals must send register messages continuously before the then-current keep alive time ends. Consequently, methods may generate a great amount of data traffic in the network and burden the network with a heavy load.

Moreover, the above-mentioned ping method and translate header, etc. are not essential items of RFC2543 and thus the terminals do not support such methods or headers.

On the other hand, problems with the RTP media stream may be as follows. Problems in the RTP step may vary depending on the applied method or protocol. The universal plug and play (UPnP) proposed by Microsoft does not operate in case of cascading NATs. Further, in order to support the plug and play (UPnP) protocol, the universal plug and play protocol may need to be applied to the conventional NATs. Great expenses may be incurred for this purpose.

In case of the external query method, the port for transmitting RTP must be the same as the port for receiving RTP. Also, the SIP message must be sent to the relevant destination using the mapping value before the mapping value obtained through the connection with the NAT probe changes to another value upon passage of a certain time. In case of the restricted cone type of NAT or the port restricted cone type of NAT, before receiving media data from the other party, the relevant media path must be activated by sending the media data. Moreover, in case of the symmetric NAT, the mapping value would be different for each destination address. Thus, the mapping value obtained through the connection with the NAT probe or the STUN server cannot be used for connection with any other party. Therefore, the above-mentioned methods may not be applicable.

Also, in case of a symmetric NAT, if the external user agent is not within the NAT, the external user agent must support the a=direction : active tag. However, this is not an essential item that must be applied in RFC2543 and thus a lot of terminals do not support this feature. Furthermore, if the external user agent is within the symmetric NAT, a specific component called RTP relay must be inserted into the middle of the RTP flow between the two user agents.

### SUMMARY OF THE INVENTION

An object of the present invention is to solve at least the above problems and/or disadvantages and to provide at least the advantages described hereinafter.

Embodiments of the present invention may attempt to resolve problems related to software upgrades of prior SIP components for NAT passage, network traffic increase, addition of SIP methods or headers for new NATs, incompatibility of SIP components of different companies and upgrade and replacement of existing NATs. Further, embodiments of the present invention may attempt to provide an SIP service method that is applicable to all types of NATs.

Embodiments of the present invention may provide an SIP service method in a network having a NAT. This may include registering private address/port of a proxy within the NAT in a static mapping table so as to be able to access the proxy within the NAT from outside the NAT. If messages come to the public IP address/port of the NAT mapped to the private IP address/port of the proxy, all SIP messages may be transmitted automatically to the private IP address/port of the proxy mapped to the public address. If the proxy intends to transmit messages to outside the NAT, a connection may be made at the NAT to the outside using the public IP address/port mapped to the private IP address/port of the proxy.

If the proxy within the NAT intends to transmit messages to outside the NAT, the SIP service method may add via header parameters, including the proxy's public IP address and port registered in the relevant NAT static mapping table rather than the proxy's private IP address and port. The messages may then be sent.

Embodiments of the present invention may also include: a first user agent's sending an SIP invite message for a second user agent to a first proxy registered in a static mapping table of the NAT located within a same domain as the first user agent. At an RTP relay located outside of the domains, multiple public IP address/port pairs may be created and stored for media processing through inter-operation with the first proxy. The first proxy may change the private access information (IP address/port pair) within the SDP message received from the first user agent to one of the multiple public access information values. The SIP invite message may be sent to the second user agent through a second proxy registered in the static mapping table of the other NAT. The second user agent may send a response message to the invite message to the first proxy through the second proxy located within the same NAT as the second user agent. Upon receipt of the response message from the second user agent, the first proxy may modify the private access information value (IP address/port pair) within the SDP to one of the remaining public access information values created at the RTP relay and send the response message to the first user agent. In order to obtain NAT binding values for establishing a voice communication path, each user agent may send specific media to the modified public access information value within the invite message or the response message and thereby the NAT binding values may be created. The created NAT binding values may be mapped to the multiple public access information values that were created previously at the RTP relay. These values may be stored. Upon receipt of the response message, the first user agent may send an acknowledgment for the response message. The call set-up may then be terminated.

After the call set-up, the SIP service method may further include the RTP relay enabling the two user agents to transmit and receive media to and from each other using the public access information and the mapped NAT binding values that the RTP relay itself possesses.

Additional advantages, objects, features and embodiments of the invention will be set forth in part in the description that follows and in part will become apparent to those having ordinary skill in the art upon examination of the following or may be learned from practice of the invention.

### BRIEF DESCRIPTION OF THE DRAWINGS

The following represents brief descriptions of the drawings in which like reference numerals represent like elements and wherein:

FIG. 1 illustrates a network structure for SIP service in a network having a NAT and an example of the SIP service according to an example arrangement;

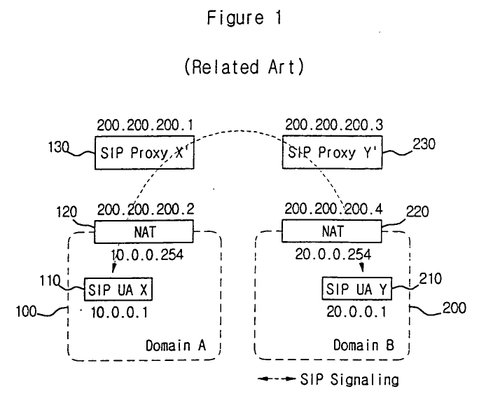

FIG. 2 illustrates a structure of a network having an SIP service method according to an example embodiment of the present invention; and

FIG. 3 is a flow chart illustrating the SIP service method in a network having a NAT according to an example embodiment of the present invention.

### DETAILED DESCRIPTION OF PREFERRED EMBODIMENTS

Preferred embodiments of a SIP service method in a network having a NAT will now be described with respect to the accompanying drawings.

Because communication between terminals with SIP protocol without any modification is difficult on the IP Internet, various Working Groups within the Internet Engineering Task Force (IETF) may propose methods to resolve this problem through Internet Drafts, etc.

Three methods have been proposed by the IETF to resolve the above-described problem(s). One arrangement is to include an Application Layer Gateway (ALG) in the NAT that recognizes the SIP protocol. Another arrangement is to use IPv6. Still another arrangement is to use Middlebox Communications (IDCOM) to control the NAT. However, actual implementation of these proposed arrangements may take a long time. Accordingly, each SIP Working Group or each relevant company may devise its own short-term method and provide the SIP service in the NAT environment using such method.

The respective short-term methods may be dependent on the protocol used by the relevant company or the NAT supporting the protocol. Thus, these methods may not be used in the NAT environments that have been used in the related arts. Instead, the SIP service can be provided by updating or replacing existing NATs.

Further, RFC2543, which is a standard recommendation of the SIP, does not provide sufficient standards for the NAT passage. Accordingly, in order to provide services using the above-described methods, a number of proxies or clients made in compliance with RFC2543 may conduct a update to RFC3261, which is a current standard, or may conduct partial modifications.

Also, protocols or methods to be used may vary depending on the type of NAT. Under these circumstances, embodiments of the present invention may provide a method for providing SIP services in a NAT environment using SIP clients or proxies that may be commonly applied to all NAT types and in compliance with RFC2543. Embodiments of the present invention may use a static mapping table of the NAT for signaling processing and RTP relay of the NAPT function for media processing.

NATs may store internal access information (internal IP address:port pair) as mapped to relevant public access information (public IP address:port pair) by using the static mapping tables regardless of the type of the NATs. Embodiments of the present invention may provide SIP services by mapping proxies in advance, storing the relevant information and then using the information without any modification.

In SIP protocol, DNS queries may be used to find a certain proxy. Thus, public access information (Public IP address:port) of proxies registered in the relevant NAT are registered in advance with the DNS name server.

Embodiments of the present invention will now be explained with reference to a symmetric NAT type, which is the most widely used method in universities and companies.

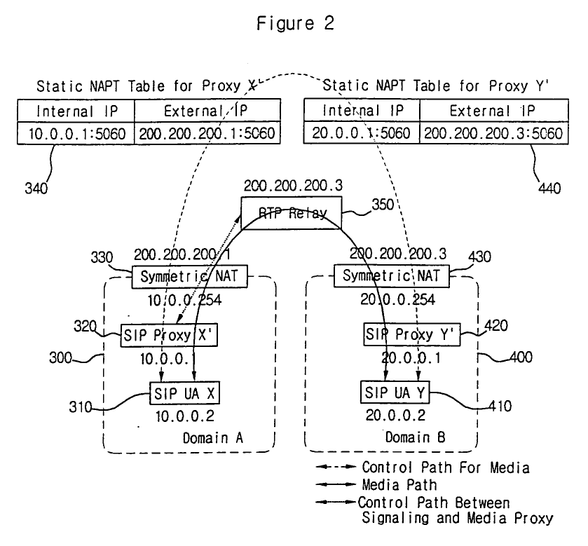

FIG. 2 illustrates a network structure for application of embodiments of the present invention. More specifically, FIG. 2 illustrates a SIP service method in a network having a NAT. FIG. 2 also illustrates exchange of data between a user agent UA X (310) of an NAT network Domain A (300) and a user agent UA Y (410) of an NAT network Domain B (400).

As shown in FIG. 2, Domain A (300) and Domain B (400) include NATs (330, 430) respectively. SIP proxies (320, 420) are included within the NATs (330, 430), for signaling processing. Private IPs of SIP proxies X′ and Y′ (320,420) are registered in the static mapping tables (340, 440) of the respective NATs (330, 430). An RTP relay (350) is provided outside of the NATs (330, 430) for transmission of media data between the NATs (330, 430).

The proxies (SIP Proxy X′, SIP Proxy Y′) (320,420) are located within the NATs to efficiently register the NAT internal users (310, 410) and to conduct facilitated passage through the NATs. The proxies (320, 420) have private IP address/port information for accessing the NAT internal users (310, 410). In the example shown in FIG. 2, the proxy (320) in Domain A (300) has private IP 10.0.0.1 and the proxy (420) in Domain B (400) has private IP 20.0.0.1. The proxies (320, 420) transmit and receive signaling messages based upon the static mapping tables (340, 440) and create and assign IP address/port in association with the RTP relay (350).

For transmission of media stream, the proxies (320, 420) check whether the receiver UA Y (410) belongs to the same domain as the transmitter UA X (310) and, determine whether to use the RTP relay (350). If it is determined that the receiver UA Y (410) belongs to a different domain, the proxies (320, 420) may exchange signals with the RTP relay (350) outside of the NATs through private signaling.

Accordingly, for accessing the relevant proxy from outside the NAT, private IP address/port of the proxy within the NAT may be registered in the NAT's static mapping table. The private IP address/port of the NAT that is assigned together at this time may be used for the connection to outside of the NAT. Thus, all SIP messages coming to the private IP address/port of the NAT are automatically transmitted to the private IP address/port of the proxy mapped to the relevant public IP address.

Also, in case that a proxy transmits messages to outside of the NAT, the NAT is connected to the outside with the public IP address/port mapped to the private IP address/port of the proxy. Preferably, the proxy adds via headers to the messages to be transmitted to the outside. The via header parameters, which are to be transmitted, contain the public IP address/port information registered in the relevant NAT's static mapping table (not the private IP address/port information of the relevant proxy).

The RTP relay (350) is located outside of the NATs (330, 430) to facilitate media transmission between the NATs (330, 430) and to control all flows of media stream from the private side to the public side. For such RTP relay (350), the IP address/port is assigned at call set-up or prior to the call step, before the media stream is received. The RTP relay (350) conducts the NAPT function regarding both source address/port and destination address/port. For this purpose, the user agents (SIP UA X, SIP UA Y) (310,410) inside of the NATs (330, 430) may have the same ports for transmitting and receiving media stream.

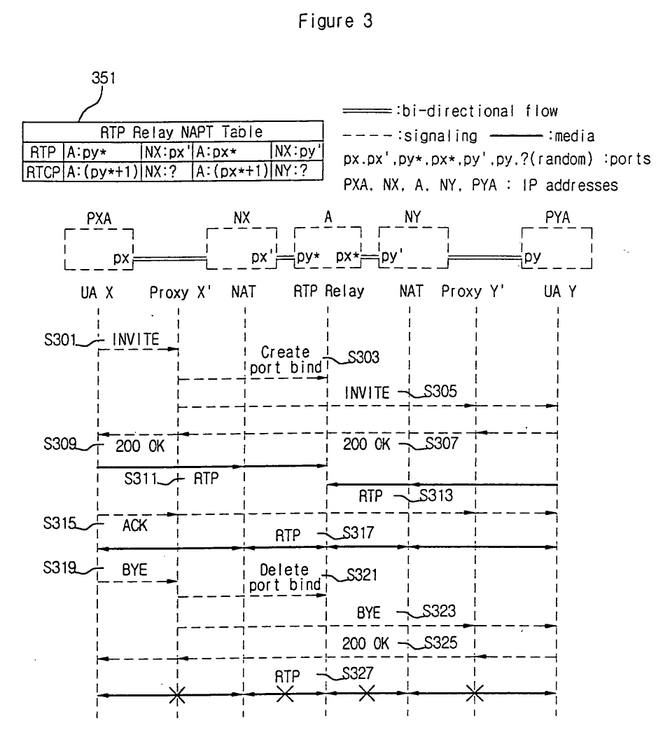

FIG. 3 illustrates a signaling method for SIP service in a network having NATs according to an example embodiment of the present invention. Other embodiments are also within the scope of the present invention. FIG. 3 illustrates flows of SIP messages from the signaling for call establishment to the media stream connection in the network shown in FIG. 2.

The user agent UA X (310) sends SIP invite message for the user agent UA Y (410) to the proxy X′ (320) registered in the static mapping table (340) of the NAT located within a same domain as the user agent UA X (310) (S301). The SDP message includes information on the private IP address/port (PXA:px) through which the user agent UA X (310) wants to receive RTP data.

Upon the proxy X′ (320)'s receipt of the invite message, the RTP relay (350) creates and stores multiple public IP address/port pairs. This is access information for media processing to be conducted in association with the proxy X′ (320) (S303). The created access information may be address/port (A:py*) to be used in inter-operation with the user agent UA X (310) and address/port (A:px*) to be used in inter-operation with the user agent UA Y (410). The RTCP also creates port binding based upon the RTP. At this time, the RTP relay (350) cannot recognize the address/port information of the NATs to which the users (310, 410) will be bound.

The proxy X′ (320) modifies the private access information (IP address/port pair) within the SDP message received from the user agent UA X (310) to one of the multiple public IP address/port pairs created by the RTP relay (350) and transmits the SIP invite message to the user agent UA Y (410) through the proxy Y′ (420) registered in the static mapping table (440) of the other NAT (S305). At this time, the SDP message includes the address/port (A:px*) of the RTP relay (350) modified by the proxy X′ (320).

The user agent UA Y (410) responds to the invite message by sending a response message (200 OK) to the proxy X′ (320) through the proxy Y′(420) inside of the NAT to which the user agent UA Y (410) itself belongs (S307). At this time, SDP message includes the private IP address/port (PYA:py) through which the user agent UA Y (410) wants to receive data.

When the proxy X′ (320) receives the response message (200 OK) of the user agent UA Y (410), the private access information (IP address:port pair) in the SDP message is modified with one (A:py*) of the remaining public IP address:port pairs created by the RTP relay (350) in advance and is sent to the user agent UA X (310) (S309).

After the user agent UA X (310) receives the response message (S309), in order to obtain the NAT binding values for establishing the voice communication path, each user agent (310, 410) creates the NAT binding value by transmitting certain media to the modified public access information value within the SDP message of the invite message or the response message. The RTP relay (350) maps the NAT binding values created in this manner to the multiple public values that were previously created and these values are stored (S311, S313).

In other words, the user agent UA X (310) transmits media (e.g., background noise) to the RTP relay (350) immediately (or substantially immediately) upon receiving the response message (200 OK) (S311). When the first RTP packet is transmitted to the RTP relay (350), the RTP relay (350) stores the NAT source address/port (NX:px′) created during the RTP packet's passage of the NAT. Then, assuming this address/port value as the external representation value for media transmission to the user agent UA X (310), the RTP relay (350) transmits all RTP data coming from the user agent UA Y (410) to this address/port (NX:px′).

The user agent UA Y (410) also transmits media immediately after (or substantially immediately after) transmitting the response message (200 OK) (S313). The RTP relay (350) stores the NAT source address/port (NY:py′) and transmits all RTP data coming from the user agent UA X (310) to this address/port (NY:py′).

Thereafter, the user agent UA X (310) transmits an acknowledgment (ACK) for the response message (S315) and then the call set-up is terminated.

Then, by using the public access information and the mapped NAT binding values that the RTP relay (350) possesses, media transmission and receipt is made betveen the two user agents (310, 410) (S317).

Once the media path passing through the NATs (330, 430) is established, keep alive messages may be transmitted periodically for the continuous activation of the established binding even while there is no action of the relevant user agent (i.e., even while there is no speech packet transmission).

If the user agent UA X (310) transmits a bye message in order to terminate the call (S319), the proxy X′ (320) transmits the bye message to the RTP relay (250) and the mapped binding values of all relevant calls created in the RTP relay are deleted (Delete port bind) (S321).

Also, the proxy X′ (320) transmits the bye message to the proxy Y′ (420) on the other side and the user agent UA Y (410) is notified accordingly (S323). Media may not be transmitted any further once a response message (200 OK) in response to the bye message is transmitted from the user agent UA Y (410) to the user agent X (310) through the proxy Y′ and the proxy X′ (S325) (S327).

As described above, according to the present invention, SIP services may be provided using the SIP components and the NATs without modification or substitution through the NAT's static mapping tables and by having the RTP relay include a NAPT function. The SIP service method may be applicable to all types of the NAT.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A Session Initiation Protocol (SIP) service method comprising:
registering a private Internet Protocol (IP) address/port of a proxy in a static mapping table of a Network Address Transition (NAT), the private IP address/port for accessing the proxy from outside the NAT; and
upon messages coming to a public IP address/port of the NAT mapped to the private IP address/port, transmitting all SIP messages to the private IP address/port.

2. The method of claim 1, further comprising connecting to outside of the NAT using the public IP address/port if the proxy intends to transmit messages to the outside of the NAT.

3. The method of claim 2, wherein connecting to the outside comprises adding via headers to the SIP messages.

4. The method of claim 3, wherein connecting to the outside further comprises registering the public IP address port in parameters of the via headers.

5. The method of claim 4, wherein the public IP address/port is registered in the via headers without registering the proxy's private IP address/port in the via headers.

6. The method of claim 4, wherein connecting to the outside further comprises transmitting the messages to the outside of the NAT.

7. A Session Initiation Protocol (SIP) service method comprising:
sending a SIP invite message from a first user agent to a first proxy registered in a static mapping table of a Network Address Translation (NAT) located within a same domain as the first user agent;
storing multiple public access information at a Real Time Protocol (RTP) relay located outside of domains for media processing;
changing, at the first proxy, private access information within a Session Description Protocol (SDP) message received from the first user agent to one of the multiple public access information; and
sending the SIP invite message to a second user agent through a second proxy registered in the static mapping table of another NAT.

8. The method of claim 7, further comprising:
sending a response message corresponding to the SIP invite message from the second user agent to the first proxy through the second proxy, the second proxy located within the same NAT as the second user agent.

9. The method of claim 8, further comprising:
modifying the private access information value within the SDP message to one of the multiple public access information stored at the RTP relay and sending the response message to the first user agent.

10. The method of claim 9, further comprising:
sending specific media to the modified public access information value within the invite message or the response message and thereby creating the NAT binding values, and mapping the created NAT binding values to the multiple public access information values that were stored at the RTP relay.

11. The method of claim 10, further comprising enabling the two user agents to transmit and receive media to and from each other using the stored public access information and the mapped NAT binding values.

12. The method of claim 11, wherein the public access information and the mapped NAT binding values are stored in the RTP relay.

13. The method of claim 10, further comprising:
upon receipt of the response message, sending an acknowledgment message from the first user agent.

14. The method of claim 13, wherein after the first user agent's receipt of the response message, the method further comprises:
storing at the RTP relay NAT source access information generated during the RTP packet's passage through the NAT, deeming the source access information as the external representation value for the first user agent's media transmission and transmitting all RTP data received from the second user agent to the source access information.

15. The method of claim 13, further comprising:
after the second user agent's transmission of the response message, transmitting the media from the second user agent, storing the NAT source access information at the RTP relay, and transmitting the RTP data received from the first user agent to the NAT source access information.

16. The method of claim 7, wherein if a media path is established between the two user agents for transmission and receipt of media stream, periodically transmitting keep alive messages in order to maintain the established binding.

17. The method of claim 7, further comprising:
if the first proxy receives a bye message from the first user agent, transmitting the bye message to the RTP relay; and
deleting binding values for all the relevant calls created at the RTP relay and thus terminating the call.

18. The method of claim 15, wherein the user agent's port for transmitting the media is the same as its port for receiving the media.

19. A Session Initiation Protocol (SIP) method comprising:
providing a private address/port of a proxy within a static mapping table; and
transmitting SIP messages to the private address/port of the proxy when messages are provided to the network.

20. The method of claim 19, further comprising connecting the network to outside of the network using a public address/port.

21. The method of claim 20, wherein connecting to the outside comprises adding via headers to the SIP messages.

22. The method of claim 21, wherein connecting to the outside further comprises registering the public IP address port in parameters of the via headers.

23. The method of claim 22, wherein the public IP address/port is registered in the via headers without registering the proxy's private IP address/port in the via headers.

24. The method of claim 22, wherein connection to the outside further comprises transmitting the messages to the outside of a Network Address Transition (NAT) of the network.

25. A Session Initiation Protocol method comprising:
sending a SIP invite message from a first user agent to a first proxy registered in a static mapping table associated with a first domain;
storing public access information at a Real Time Protocol relay;
modifying a Session Description Protocol (SDP) message to include public access information; and
sending the SIP invite message from a second proxy to a second user agent, the second proxy being registered in a static mapping table associated with a second domain.

26. The method of claim 25, further comprising:
sending a response message corresponding to the SIP invite message from the second user agent to the first proxy through the second proxy, the second proxy located within the same NAT as the second user agent.

27. The method of claim 26, wherein modifying the SDP message comprises modifying private access information value within the SDP message to one of the multiple public access information stored at the RTP relay and sending the response message to the first user agent.

28. The method of claim 27, further comprising:
sending specific media to the modified public access information value within the invite message or the response message and thereby creating the NAT binding values, and mapping the created NAT binding values to the multiple public access information values stored at the RTP relay.

29. The method of claim 28, further comprising:
upon receipt of the response message, sending an acknowledgment message from the first user agent.
